(19) United States
(12) Patent Application Publication
(10) Pub. No.: US 2024/0417311 A1
(43) Pub. Date: Dec. 19, 2024

(54) PHASE SEPARATED COMPOSITE GLASS MATERIALS

(71) Applicant: CORNING INCORPORATED, CORNING, NY (US)

(72) Inventors: Zagorka Dacic Gaeta, Ithaca, NY (US); Lisa Ann Lamberson, Painted Post, NY (US); Eric James Nichols, Corning, NY (US)

(21) Appl. No.: 18/703,158

(22) PCT Filed: Oct. 28, 2022
(86) PCT No.: PCT/US2022/048136

§ 371 Date: Apr. 19, 2024

Related U.S. Application Data
(60) Provisional application No. 63/398,698, filed on Aug. 17, 2022.
(60) Provisional application No. 63/274,062, filed on Nov. 1, 2021.

(51) Int. Cl. C03C 3/097; C03B 5/235

(52) U.S. Cl. CPC C03C 3/097; C03B 5/235

(57) ABSTRACT

A phase separated composite glass has a first phase and a second phase. The first phase has an average microstructure size greater than a natural coursing limit of the phase separated composite glass (i.e., outside of what would be achievable by natural phase separation or otherwise in violation of the morphology constraints defined by a liquid-liquid immiscibility dome for the given bulk composition). Methods of preparing a phase separated composite glass based on a phase separated precursor glass or a template glass. Methods include combining a milled first glass corresponding to the first phase and a milled second glass corresponding to the second phase to form a glass mixture. Methods include melting the glass mixture at a temperature from about 25° C. to 0° C. less than an isotherm tie-line between endpoints of a pseudo-binary immiscibility dome defined by the phase separated precursor glass or the template glass.

### CROSS REFERENCE TO RELATED APPLICATION

This application claims the benefit of priority under 35 U.S.C. § 119 of U.S. Provisional Application Ser. No. 63/398,698 filed on Aug. 17, 2022, and U.S. Provisional Application Ser. No. 63/274,062 filed on Nov. 1, 2021, the content of which is relied upon and incorporated herein by reference in their entireties.

### FIELD

The disclosure relates to phase separated composite glass, methods of manufacture, and glass articles containing the same.

### BACKGROUND

Phase separation is a natural process that occurs in some glasses in the liquid phase, whereby the glass separates into two distinct phases resulting in a loss of homogeneity and modified physical and chemical properties. A number of economically important glass innovations have utilized phase separated glass. For example, Pyrex® and Vycor® are phase separated Na-borosilicate composites.

There is a challenge that the natural phase separation process is governed by a complex interplay of thermodynamic and kinetic factors in a multi-component material. Due to such complexity, natural phase separation does not lend itself to rational modification of process parameters in order to achieve a particular predetermined product; for various phase separated products, such process design can be unreasonably costly, prohibitively time consuming, or simply not feasible. For any given bulk composition, some combinations of phase size or morphology cannot be obtained by natural phase separation.

### SUMMARY

The present disclosure relates generally to phase separated composite glass and methods of making the same. As described herein, the disclosure provides access to phase separated composite glass having microstructures outside of what would be achievable by natural phase separation, or otherwise in violation of the morphology constraints defined by a liquid-liquid immiscibility dome for the given bulk composition.

For example, the disclosure provides a glass article comprising a phase separated composite glass having a first phase and a second phase, wherein the first phase has an average microstructure size greater than a natural coarsening limit of the phase separated composite glass. In aspects, the microstructure can be a droplet.

The disclosure also provides a method of preparing a phase separated composite glass by using a precursor glass. In this method, a precursor glass is analyzed and provides reference values that are utilized to provide parameters in the method. The method involves obtaining a phase separated precursor glass having a first phase and a second phase. The first phase and the second phase is analyzed to determine the composition of each phase, and then the determined composition is used to individually obtain a first glass and a second glass approximately corresponding to the composition of the first phase and the second phase, respectively. The first glass is milled to a first cullet size corresponding to a predetermined microstructure size, and the second glass is milled to a second cullet size less than the first cullet size of the first glass. Optionally, the first glass, milled first glass, second glass, and/or milled second glass is individually heated to a temperature corresponding to an isotherm tie-line between endpoints of a pseudo-binary immiscibility dome defined by the first phase and second phase of the phase separated precursor glass. The milled first glass and the milled second glass are combined to from a glass mixture. The glass mixture is melted at a temperature from about 25° C. to 0° C. less than an isotherm tie-line between endpoints of a pseudo-binary immiscibility dome defined by the first phase and second phase of the phase separated precursor glass. Subsequent quenching provides the phase separated composite glass.

The disclosure further provides a method of preparing a phase separated composite glass based on a template glass. In this method, parameter values are utilized that correspond to reference values of a template glass. The method involves selecting a phase separated template glass having a first phase and a second phase, and determining approximate compositions of each of a first phase and a second phase of the thermodynamically phase separated template glass. Next, the method involves obtaining a first glass approximately corresponding to the composition of the first phase, and then milling it to a first cullet size corresponding to a predetermined microstructure size, which can be greater than an upper bound of corresponding microstructure size in the template glass. The method also involves obtaining a second glass approximately corresponding to the composition of the second phase and milling it to a second cullet size less than the first cullet size of the first glass. Optionally, the first glass, milled first glass, second glass, and/or milled second glass is individually heated to a temperature corresponding to an isotherm tie-line between endpoints of a pseudo-binary immiscibility dome defined by the first phase and second phase of the phase separated precursor glass. The first and second glass are combined to from a glass mixture. The glass mixture is melted at a temperature from about 25° C. to 0° C. less than an isotherm tie-line between endpoints of a pseudo-binary immiscibility dome defined by the first phase and the second phase of the phase separated template glass. Subsequent quenching provides the phase separated composite glass.

Advantages, some of which are unexpected, are achieved by various aspects of the present disclosure. The present disclosure can advantageously provide access to phase separated compositions having microstructures which would otherwise be inaccessible via natural phase separation. As an example, various phase separation glass compositions have desirable characteristics, but suffer from natural constraints on microstructure size or morphology that renders them unsuitable for their predetermined purpose. The present disclosure can provide equivalent glass compositions but with greater microstructure (e.g., droplet) size, or with a more stable microstructure morphology. The present disclosure can provide greater control over microstructure size relative to natural phase separation, which thus provides a further advantage of permitting rational engineering of phase separated glass materials. Additionally, the disclosure provides various compositions having desirable stability, e.g., in terms of thermodynamic or kinetic stability, free from spontaneous changes to microstructure, such as changes to phase composition, size, or morphology, at ordinary temperatures for use, storage, or processing.

Natural phase separation imposes various constraints on size and morphology of resulting microstructures. Composites and methods described herein are decoupled from the constraints of natural phase separation and thus permit access to materials that would otherwise appear to be in violation of the morphology constraints defined by a liquid-liquid immiscibility dome for the given bulk composition. Typically, phase separated glass is prepared by formulating a precursor material that is heat treated to form a homogeneous melt, which then undergoes phase separation, from the homogenous state to produce a microstructure. In this typical approach, microstructure formation is the result of thermodynamic and kinetic effects, which can be understood such that thermodynamics provide for the direction of reaction, whereas kinetics provide for the rate of reaction including whether or not the reaction happens in a meaningful time frame. Natural phase separation can result in fine structures (such as when given a short time period for coarsening prior to quench) or coarse structures (such as when given a longer time period for coarsening prior to quench). Kinetic considerations further come into play when considering rate of quenching, which can lead to crystals (slow quench) or maintain a vitreous state (fast quench). Microstructures may arise during maintenance at a given elevated temperature, or may occur upon cooling. Natural phase separation and the resulting microstructure character is a thermodynamically mediated process. Once phase separation has occurred, the resulting phase separated glass can be quenched by rapidly cooling to a temperature sufficiently low so as to kinetically trap the achieved phase chemistry. If not rapidly quenched, the phase separated glass equilibrates toward a low energy state defined by an immiscibility curve. As used herein, a “naturally phase separated” glass refers to a phase separated glass resulting from thermodynamically driven phase separation of a homogeneous melt. The term can refer to naturally phase separated glass that is permitted to equilibrate to a low free energy state over a period of time, or refer to naturally phase separated quenched prior to reaching the lowest free energy, or both. A phase separated glass that is quenched prior to reaching a low free energy state, may undergo additional phase changes upon reheating or further processing. However, the natural phase separation process permits only limited control over the size and morphology of the resulting microstructure, which is determined from an interplay of thermodynamic and kinetic driving forces. Certain combinations of phase size or morphology cannot be obtained by natural phase separation, but can be obtained using the methods herein.

The disclosure provides for the following aspects, the numbering of which is not to be construed as designating levels of importance:
Aspect 1. A glass article comprising a phase separated composite glass having a first phase and a second phase, wherein the first phase has an average microstructure size greater than a natural coarsening limit of the phase separated composite glass.
Aspect 2. The glass article of aspect 1, wherein the first phase is a droplet phase, the second phase is a matrix phase, the average microstructure size is an average droplet size, and the average droplet size of the droplet phase is greater than the natural coarsening limit of the phase separated composite glass.
Aspect 3. A glass article comprising a phase separated composite glass having a first phase comprising a droplet phase and a second phase comprising a matrix phase, wherein the droplet phase has an average droplet size greater than a natural coarsening limit of the phase separated composite glass.
Aspect 4. The glass article of any one of aspects 1-3, wherein microstructure size is defined by an effective diameter as measured by electron microscopy.
Aspect 5. The glass article of any one of aspects 1-4, wherein the natural coarsening limit is determined by preparing a homogeneous melt of a composite glass having an equivalent bulk composition to the phase separated composite glass, cooling the homogeneous melt so as to obtain a thermodynamically phase separated composite glass, and measuring an upper bound of microstructure (e.g., droplet) size resulting in the thermodynamically phase separated composite glass.
Aspect 6. The glass article of any one of aspects 1-4, wherein an alternative phase separated composite glass obtained from cooling another homogeneous melt of a composite glass having an equivalent bulk composition to the phase separated composite glass to obtain a thermodynamically phase separated composite glass results in a spinodal decomposition morphology.
Aspect 7. The glass article of any one of aspects 1-4, wherein the phase separated composite glass has an interfacial free-energy of mixing that is lower relative to an alternate interfacial free-energy of mixing resulting from cooling another homogeneous melt of a composite glass having an equivalent bulk composition to the phase separated composite glass.
Aspect 8. The glass article of any one of aspects 1-4, wherein the first phase and the second phase have compositions approximately corresponding to tie-line endpoints of a pseudo-binary immiscibility dome defining compositions of phases resulting from cooling another homogeneous melt of a composite glass having an equivalent bulk composition of the phase separated composite glass.
Aspect 9. The glass article of any one of aspects 1-8, wherein the first phase has a microstructure size at least 10 times greater than the natural coarsening limit of the phase separated composite glass.
Aspect 10. The glass article of any one of aspects 1-9, wherein the first phase has a microstructure size at least 10,000 times greater than the natural coarsening limit of the phase separated composite glass.
Aspect 11. The glass article of any one of aspects 1-10, wherein the phase separated composite glass has a bulk composition comprising SiO₂ as a primary component.
Aspect 12. The glass article of any one of aspects 1-11, wherein the phase separated composite glass has a bulk composition comprising:
   from about 60 to about 80 mol % SiO₂;
   from about 5 to about 20 mol % B₂O₃;
   from about 0.5 to about 10 mol % Al₂O₃;
   from about 0.5 to about 5 mol % P₂O₅;
   from about 5 to about 20 mol % one or more alkaline earth oxide; and
   from about 0 to about 5 mol % one or more alkali metal oxide,
   wherein the droplet phase has a droplet size of about 0.01 millimeters to about 10 millimeters.
Aspect 13. The glass article of any one of aspects 1-12, wherein an interphase between the first phase and the second phase is from about 100 nanometers to about 1% of the average microstructure size.
Aspect 14. A method of preparing a phase separated composite glass, comprising:
   obtaining a phase separated precursor glass having a first phase and a second phase; determining a composition of the first phase and the second phase;
   individually obtaining a first glass and a second glass approximately corresponding to the composition of the first phase and the second phase, respectively;
   milling the first glass to a first cullet size corresponding to a predetermined microstructure size;
   milling the second glass to a second cullet size less than the first cullet size of the first glass;
   combining the milled first glass and the milled second glass to form a glass mixture;
   melting the glass mixture at a temperature from about 25° C. to 0° C. less than an isotherm tie-line between endpoints of a pseudo-binary immiscibility dome defined by the first phase and the second phase of the phase separated precursor glass; and then
   quenching, so as to provide the phase separated composite glass.
Aspect 15. The method of aspect 14, wherein the phase separated composite glass has a microstructure with a microstructure morphology, a microstructure size, or both that is in violation of natural phase separation constraints as defined by the pseudo-binary immiscibility dome based on phase separation from cooling a homogeneous melt of the phase separated precursor glass.
Aspect 16. The method of any one of aspects 14-15, wherein the microstructure size is greater than an upper bound of corresponding microstructure size in the precursor glass.
Aspect 17. The method of aspect 16, wherein the phase separated composite glass has a droplet phase and a matrix phase, and the microstructure is droplets.
Aspect 18. The method of any one of aspects 14-17, wherein the milled first glass and milled second glass are combined at the same relative proportion as the first phase and second phase in the precursor glass.
Aspect 19. The method of any one of aspects 14-17, wherein the milled first glass and the milled second glass are combined at different relative proportion compared to the first phase and the second phase in the phase separated precursor glass.
Aspect 20. The method of any one of aspects 14-19, wherein the phase separated composite glass is a liquid-liquid binary system or liquid-liquid pseudo-binary system.
Aspect 21. The method of any one of aspects 14-20, wherein the phase separated composite glass has phases having compositions approximately corresponding to that of tie-line endpoints of the pseudo-binary immiscibility dome defined by the first phase and the second phase of the phase separated precursor glass.
Aspect 22. The method of any one of aspects 14-121, wherein the phase separated composite glass has an average microstructure size greater than a natural coarsening limit of the phase separated precursor glass.
Aspect 23. The method of any one of aspects 14-21, further comprising, after individually obtaining the first glass and the second glass but before combining the milled first glass and the milled second glass:
   heating the first glass or the milled first glass at a temperature at a temperature approximately corresponding to the isotherm tie-line; and
   heating the second glass or the milled second glass at a temperature at a temperature approximately corresponding to the isotherm tie-line.
Aspect 24. The method of any one of aspects 14-21, wherein an average microstructure size of the first phase in the phase separated composite glass is within about 5% of the first cullet size.
Aspect 25. The method of any one of aspects 14-24, wherein the glass mixture is held at the temperature from about 25° C. to 0° C. less than the isotherm tie-line for a period of time from about 1 minute to about 20 minutes.
Aspect 26. A method of preparing a phase separated composite glass, comprising:
   selecting a thermodynamically phase separated template glass prepared by cooling a homogeneous melt of a template glass to obtain a first phase and a second phase;
   obtaining a first glass approximately corresponding to a composition of the first phase and milling it to a first cullet size corresponding to a predetermined microstructure size greater than an upper bound of corresponding microstructure size in the thermodynamically phase separated template glass;
   obtaining a second glass approximately corresponding to a composition of the second phase and milling it to a second cullet size less than the first cullet size of the first glass;
   combining the milled first glass and the milled second glass to form a glass mixture;
   melting the glass mixture at a temperature from about 25° C. to 0° C. less than an isotherm tie-line between endpoints of a pseudo-binary immiscibility dome defined by the first phase and the second phase of the thermodynamically phase separated template glass; and
   quenching, so as to provide the phase separated composite glass.
Aspect 27. The method of aspect 26, further comprising, after individually obtaining the first glass and the second glass but before combining the milled first glass and the milled second glass:
   heating the first glass or the milled first glass at a temperature at a temperature approximately corresponding to the isotherm tie-line; and
   heating the second glass or the milled second glass at a temperature at a temperature approximately corresponding to the isotherm tie-line.
Aspect 28. The method of any one of aspects 26-27, wherein an average microstructure size of the first phase in the phase separated composite glass is within about 5% of the first cullet size.
Aspect 29. The method of any one of aspects 26-28, wherein the glass mixture is held at the temperature from about 25° C. to 0° C. less than the isotherm tie-line for a period of time from about 1 minute to about 20 minutes.
Aspect 30. The method of any one of aspects 26-29, wherein the phase separated composite glass has a microstructure with morphology, size, or both that is in violation of natural phase separation constraints as defined by a pseudo-binary immiscibility dome based on phase separation from cooling a homogeneous melt of the phase separated template glass.
Aspect 31. The method of any one of aspects 26-30, wherein the microstructure size is greater than an upper bound of corresponding microstructure size in the template glass.
Aspect 32. The method of any one of aspects 26-31, wherein the phase separated composite glass has an average microstructure size greater than a natural coarsening limit of the phase separated template glass.
Aspect 33. The method of any one of aspects 26-32, wherein the milled first glass and milled second glass are combined at the same relative proportion as the first phase and second phase in the template glass.
Aspect 34. The method of any one of aspects 26-33, wherein the milled first glass and milled second glass are combined at different relative proportion compared to the first phase and second phase in the template glass.
Aspect 35. The method of any one of aspects 26-34, wherein the phase separated composite glass is a liquid-liquid binary system or liquid-liquid pseudo-binary system.
Aspect 36. The method of any one of aspects 26-35, wherein the phase separated composite glass has a droplet phase and a matrix phase, and the microstructure is droplets.
Aspect 37. The method of any one of aspects 14-36, wherein an interphase between the first phase and the second phase is from about 100 nanometers to about 1% of the average microstructure size.
Aspect 38. The method of any one of aspects 14-37, wherein the phase separated composite glass has a bulk composition comprising:
   from about 60 to about 80 mol % SiO₂;
   from about 5 to about 20 mol % B₂O₃;
   from about 0.5 to about 10 mol % Al₂O₃;
   from about 0.5 to about 5 mol % P₂O₅;
   from about 5 to about 20 mol % one or more alkaline earth oxide; and
   from about 0 to about 5 mol % one or more alkali metal oxide,
   wherein the average droplet size of the first phase is from about 0.01 millimeters to about 10 millimeters.

### DESCRIPTION OF THE DRAWINGS

The drawings illustrate generally, by way of example, but not by way of limitation, various embodiments discussed herein.

FIG. 1 is a gray-scale transmission electron microscope (TEM) image of a naturally phase separated material having a maximum droplet size of approximately 500 nm, which represents the natural coarsening limit in the composition.

FIG. 2A-2B illustrates the relationship between miscibility curves, mole fraction, and morphology in a naturally phase separated material: (A) a chart depicting an example immiscibility dome, which includes an outer dome that represents a miscibility/immiscibility curve, an inner dome which reflects morphologic constraints, and an example tie-line isotherm; and (B) a pair of scanning electron microscopy (SEM) images illustrating a droplet-in-matrix morphology (left) and a spinodally decomposed morphology (right).

FIG. 3 is a chart depicting an example immiscibility dome with overlying modeled images describing the phase morphology corresponding to underlying position in the immiscibility dome.

FIG. 4 is a diagram illustrating an example process for preparing a phase-separated material from a precursor glass.

FIG. 5 is a diagram illustrating an example process for preparing a phase-separated material based on analyzing of a template glass.

FIG. 6A-6B depicts a phase separated composite glass having a droplet size greater than the natural coarsening limit: (A) a photograph of the a phase separated composite glass in a 2.54 centimeters (cm) (1 inch)×2.54 cm (1 inch) Pt boat, showing droplets having a size of approximately 5 mm; (B) a chart illustrating the difference in surface composition as determined by scanning electron microscopy (SEM) and energy dispersive spectroscopy (EDS) along a transition region from a droplet region (high-index, modifier rich) to a matrix region (low-index, silica-rich).

### DETAILED DESCRIPTION

Reference will now be made in detail to certain embodiments of the disclosed subject matter, examples of which are illustrated in part by reference to the accompanying drawings. While the disclosed subject matter will be described in conjunction with the enumerated claims, it will be understood that the exemplified subject matter is not intended to limit the claims to the disclosed subject matter.

The disclosure relates, generally, to phase separated composite glass having microstructures outside of what would be achievable by natural phase separation, or otherwise in violation of the morphology constraints defined by a liquid-liquid immiscibility dome for the given bulk composition.

As used herein, a “phase separated” composite glass refers to a glass composition comprising two or more immiscible glass phases. Phase separation is a process that occurs in some glasses in the liquid phase, whereby the glass can separate into two distinct liquid chemistries, which do not intermix with one another. Phases can provide various microstructures, including droplets (or spheres), layers, or spinodal forms. The phases can be liquid or solid. For example, phases can be liquid when they separated while in a melt state; phases can be solid when cooled and kinetically locked into a rigid structure; and in aspects, the same phase can be both liquid when separated in a melt state and solid when cooled and kinetically locked into a rigid (e.g., solid) structure. Two subsets of solids can occur in a phase at low temperature: vitreous (glass-type) solids or crystalline solids. Crystalline solids can result when two liquids are immiscible at high temperature, but the quench rate is not sufficiently fast to prevent crystallization in one or both phases (or quenching is sufficiently slow as to permit crystallization in one or both phases). Vitreous (glass-type) solids can occur when the quench rate is sufficiently fast to prevent crystallization in one or both phases. In further aspects, the “phase separated” composite glass of the present disclosure can be a liquid-liquid binary or pseudo-binary system. Liquid-liquid systems can be, for example, liquid at an elevated temperature, e.g., at or above a melt temperature, phase separation temperature, or glass transition temperature, and solid (rigid) at a temperature below the glass transition temperature, melt temperature, ambient temperature, or room temperature. Thus, a “phase separated” composition can refer to a given glass in its melt state having two or more phases, or to the resulting glass upon quenching the phase separated melt, or both.

As used herein, the term “microstructure” refers to the morphology, size, and relative composition of phases. The term, depending on context, can refer to the phase structure of the overall system, the phase structure of only one phase in the system, or even the structure of an individual occurrence droplet. As used herein, a “discontinuous phase” refers to a phase that comprising domains that are not physically connected by material of that phase. An example of a discontinuous phase is the droplet phase in a droplet-in-matrix morphology. As used herein, “droplet-in-matrix” morphology includes “sphere-in-matrix” morphology. Although droplets include spheres, it is not intended that droplet morphology be limited solely to sphere-shaped droplet morphologies. For example, the microstructure can result in layers, such as when observed in a 2.54 centimeters (cm) (1 inch)×2.54 cm (1 inch) platinum (Pt) boat.

As used herein, a “naturally phase separated,” “thermodynamically phase separated,” “natural phase separation,” and the like refers to a phase separated glass resulting from thermodynamically driven phase separation of a homogeneous melt. Throughout the disclosure, a phase separated glass is considered to be “naturally phase separated” if it is held at the corresponding temperature (e.g., phase separation temperature) associated with the phase separation for 24 hours. As used herein, a natural coarsening limit corresponds to an extremum (e.g., maximum) in microstructure size after equilibration. Equilibrium refers to the situation where the phases no longer change over time. As used herein, equilibration of phases is considered to be achieved by holding the composition at a phase separation temperature for 24 hours. With this definition, the microstructure does not change within an industrially relevant time frame. In contrast, an unequilibrated phase separated composition can undergo spontaneous changes to microstructure, such as changes to phase composition, size, or morphology, upon heat treatment, processing, or other uses. Without wishing to be bound by theory, the natural coarsening limit of a given bulk composition reflects the influence of chemical structure and transport properties within the bulk composition, including the effect of viscosity.

Unless otherwise indicated, the “natural coarsening limit” refers to an upper bound of microstructure (e.g., droplet) size occurring from natural phase separation and subsequent equilibration of the resulting phases for a given bulk composition. Throughout the disclosure, the natural coarsening limit is measured for a “naturally phase separated” glass as the largest microstructure size observed in a sample volume equivalent to at least a 2.54 cm (1 inch)×2.54 cm (1 inch) Pt boat. The natural coarsening limit can be described in terms of maximum measured microstructure size (e.g., droplet size). Microstructures are measured according to effective diameter. As used herein, “effective diameter” means a diameter that produces the same area or volume as the measured microstructure. For example, for a two-dimensional image (e.g., microscopy image), the effective diameter has the same area as microstructure shown (i.e., the area is multiplied by 4/x and then the square root is taken). For droplets (e.g., spheres), the effective diameter can correspond to an actual diameter. Such measurements are made by measuring microscopy images (e.g., TEM or SEM images) of the composite glass. In some aspect, size distribution can be used, for example: an effective diameter for which ninety percent, or ninety-nine percent, of the population has a smaller size. The natural coarsening limit for a given composition can be determined experimentally or computationally. In the context of a droplet-in-matrix, or other discontinuous-continuous type microstructure, the relevant microstructure size is the droplet, or discontinuous microstructure. Spinodally decomposed, or other connected or interpenetrating microstructure systems, do not represent coarsening and thus do not contribute to the relevant microstructure size for determining the natural coarsening limit of a given composition. As such, a spinodally decomposed system (lacking a droplet phase) and other interconnected phase systems would correspond to a natural coarsening limit of zero. While spinodal phases can exhibit a type of coarsening corresponding to change in relative interfacial free energy mediated by kinetic and transport limitations, the term “natural coarsening limit” is a value reflecting coarsening of discrete, non-interconnected phase microstructures (such as droplets) unless expressly indicated otherwise. In aspects, a sufficiently large droplet phase, or a sufficiently flat pancake-shaped droplet, can represent a layer that can reflect coarsening.

As used herein, “droplet size” refers to the size of droplets measured according to effective diameter. Droplet sizes can be described in terms of median, average (mean), mode, or maximum droplet sizes. Such measurements can be made by measuring microscopy images, e.g., TEM or SEM images of the composite glass. In some aspect, size distribution can be used to describe droplet size for example: a droplet size corresponding to the effective diameter for which fifty percent, ninety percent, or ninety-nine percent, of the population has a smaller size.

As used herein, a “bulk composition” refers to a composite glass composition defined in terms of its chemical constituents, without differentiating based on microstructure or phase distribution, such as would be used to describe a homogeneous melt of the given composite. Bulk composition can be determined using inductively coupled plasma mass spectroscopy (ICP-MS) or optical emission spectroscopy (OES).

As used herein, a “phase composition” refers to the composition of a given phase in terms of its chemical constituents, without differentiating based on size or morphology, such as would be used to describe a homogeneous melt of the isolated phase. Phase composition can be determined via microprobe, TEM-EDS, or by using computational image analysis, or by a combination thereof.

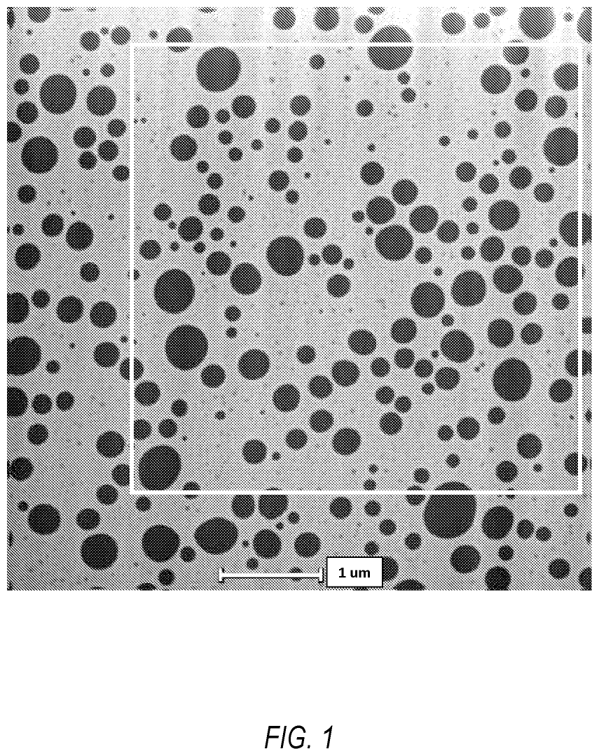

FIG. 1 is a gray-scale transmission electron microscope (TEM) image, which illustrates an example of a naturally phase separated composite glass having a droplet-in-matrix microstructure, and which shows droplets a maximum size of approximately 500 nm. Here, the natural coarsening limit of the composite glass can be determined by selecting a representative area on the microscopy image (e.g., a 5 μm×5 μm area), and measuring the effective diameter of droplets.

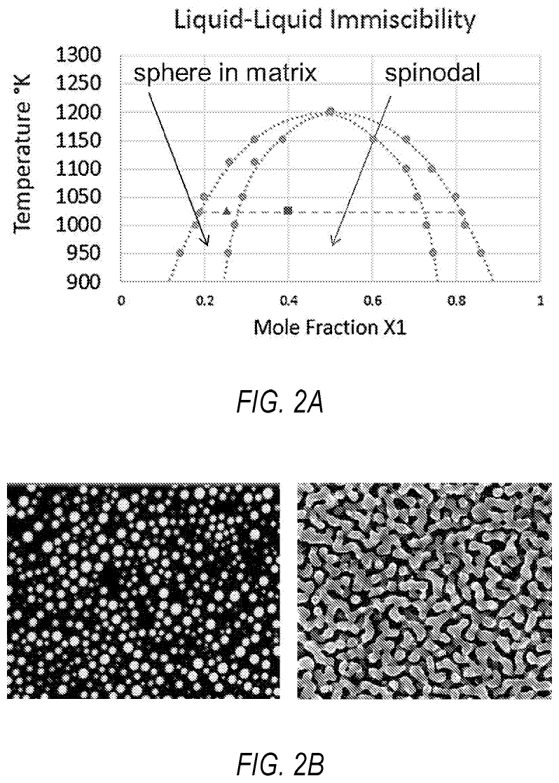

FIG. 2A depicts an example immiscibility dome, which illustrates the relationship between phase structure, temperature, and composition (as mole fraction of a binary or pseudo-binary system). Natural phase separation is driven by thermodynamic forces, which have a magnitude that is a function of the glass chemistry and temperature. For a given glass prone to liquid-liquid phase separation, there is a phase diagram that exhibits a liquid-liquid immiscibility dome that ties together the possible combinations of the phases and their fractions with the temperature at which the phase separation is occurring. The immiscibility dome provides the compositions of the phases that would form at a given temperature, and also provides the miscibility and morphology constraints which would be present during natural phase separation of a given material and imposed on the resulting product.

An immiscibility dome includes an outer dome (immiscibility curve) that represents the limits of immiscibility, and an inner dome which reflects a spinodal boundary imposing morphologic constraints. The area beneath the inner dome (spinodal boundary) represents natural phase separation temperatures and compositions that result in spinodal decomposition. The area between the spinodal boundary and the miscibility curves represents natural phase separation temperatures and compositions that result in a meta-stable microstructure, such as a droplet-in-matrix microstructure. FIG. 2A further provides an example of a tie-line isotherm, which provides two endpoints where it intersects the immiscibility curve. The endpoints define compositions of the corresponding phases. To illustrate, FIG. 2A includes a square that represents a composition having a mole fraction of 0.4, which when naturally phase separated at about 1025° C. results in a spinodally decomposed (unstable) microstructure; it also includes a triangle that represents a composition having a composition having a mole fraction of about 0.25, which when naturally phase separated at about 1025° C. results in a droplet-in-matrix (meta-stable) microstructure. For both compositions, tie-line endpoints indicate a first phase composition having a mole fraction that is approximately 0.2, and a second phase having a mole fraction that is approximately 0.8.

FIG. 2B provides a pair of electron microscopy images, which illustrates the differences between a droplet-in-matrix (i.e., sphere-in-matrix) morphology (left) and a spinodal morphology (right).

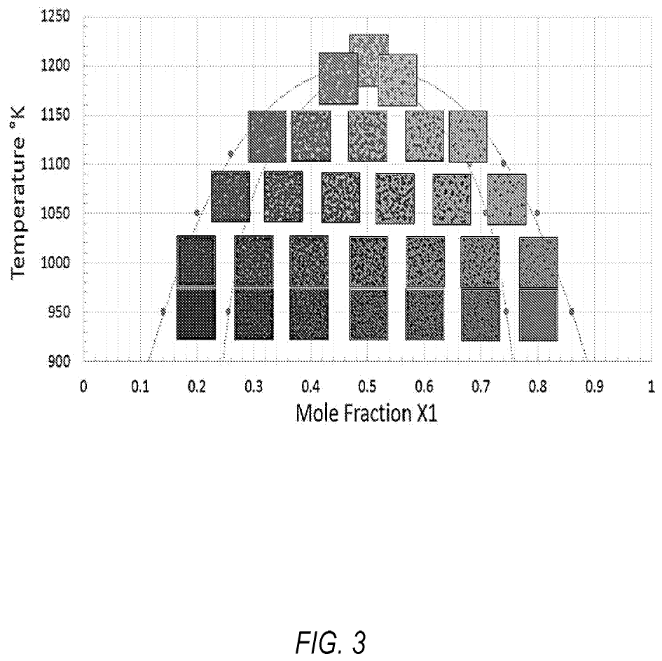

FIG. 3 depicts an example immiscibility dome having overlaid modeled images describing the phase morphology corresponding to an underlying position in the immiscibility dome. The depicted morphology is a 2D cross-section. In the droplet range, circles correspond to spheres, while within the spinodal boundary there is 3D interconnection between the phases beyond what is visualized by the 2D modeled microstructure. The modeled images were obtained by 28 runs of a phase-separation computational model across the entire temperature/bulk composition parameter space for a sample glass. This figure illustrates that morphology and droplet size in a naturally phase separated composition change as a function of phase separation temperature and bulk composition. As such, miscibility and spinodal curves of the dome serve to limit microstructure size and shape, which are governed by where the composition lies on the immiscibility dome.

Coarseness of microstructures increases with temperature, due to the effect of temperature on thermodynamic and transport effects within the glass. This effect is shown by the modeled images in FIG. 3.

The present disclosure provides a phase separated composite glass, and glass articles derived therefrom, wherein the phase separated composite glass has a first phase and a second phase, at least one of which has a microstructure with a size, morphology, or both, that is in violation of natural phase separation constraints as defined by a binary, or pseudo-binary, immiscibility dome based on the phase separation resulting when cooling a homogeneous melt having the same bulk composition. The disclosure also provides a glass article comprising a phase separated composite glass having a first phase and a second phase, wherein the first phase has an average microstructure size greater than a natural coarsening limit of the phase separated composite glass. For example, the first phase can be a droplet phase and the second phase can be a matrix phase, and the microstructure can be a droplet.

The phase separated composite glass can have various microstructures outside of what is achievable from natural phase separation of the same bulk composition. In aspects, the phase separated composite glass can have a phase with a microstructure size greater than its natural coarsening limit, or it can have a droplet-in-matrix morphology wherein natural phase separation of the same bulk glass (composition) results in a spinodally decomposed structure. In aspects, the phase separated composite glass can have a phase other than an interconnected phase. In aspects, the phase separated composite glass can have a layered structure. In aspects, the phase separated composite glass can have a phase other than a spinodal phase. As a further example, the present disclosure provides a glass article comprising a phase separated composite glass having a droplet phase and a matrix phase, wherein the droplet phase has an average droplet size greater than a natural coarsening limit of the phase separated composite glass.

Such violations of natural phase separation can be readily identified by performing natural phase separation on the subject glass, or by comparison to a naturally phase separated reference glass having the same bulk composition, or by referencing predetermined values. The reference glass can be obtained by preparing a homogeneous melt using substantially the same bulk composition, then cooling the homogeneous melt and permitting it to phase separate. In some aspects, a period of phase equilibration is provided. The natural coarsening limit can be determined from the reference glass based on an upper bound of droplet size, which can be measured by electron microscopy as described herein. A naturally phase separated glass having a spinodally decomposed morphology has a natural coarsening limit of zero. Violations of natural phase separation can also be determined by reference to a predetermined immiscibility dome or computational model generated for the given material, example of which are shown in FIG. 2A and FIG. 3. For example, referring to FIG. 2A, a phase separated composite glass corresponding to the square on the tie line, but having a droplet-in-matrix structure would correspond to a violation of natural phase separation. As another example, referring to FIG. 3, a phase separated composite glass having a droplet size greater than the upper limit of droplet sizes available within the miscibility curve would represent a violation of natural phase separation.

The phase separated composite glass can have an average microstructure (e.g., droplet) size of at least or about 10, 50, 100, 500, 1,000, 2,000, 3,000, 4,000, 5,000, 6,000, 7,000, 8,000, 9,000, or 10,000 times greater than the natural coarsening limit of the phase separated composite glass. In further aspects, the average microstructure (e.g., droplet) size is up to 10, 50, 100, 500, 1,000, 2,000, 3,000, 4,000, 5,000, 6,000, 7,000, 8,000, 9,000, or 10,000 times greater than the natural coarsening limit of the phase separated composite glass, or between about 10 to 100, 100 to 1,000, 1,000 to 5,000, or 5,000 to 10,000. In aspects, ninety percent and/or ninety-nine percent of the microstructures can be at least 1, 10, 50, or 100 times greater than the natural coarsening limit of the phase separated composite glass. The phase separated composite glass can have a microstructure (e.g., droplet) size of at least or about 1 μm, 5 μm, 10 μm, 50 μm, 100 μm, 0.5 mm, 1 mm, or 5 mm. In further aspects, the microstructure (e.g., droplet) size is up to 1 μm, 5 μm, 10 μm, 50 μm, 100 μm, 0.5 mm, 1 mm, 5 mm, or 10 mm. Because coarseness of microstructures increases with temperature, it is surprising that even greater coarseness can be obtained by targeting a temperature lower than the upper bound of the immiscibility dome (below the consolute temperature, or upper temperature at which separate phases are thermodynamically stable). That is, the compositions and methods described herein can achieve larger microstructure sizes that can be contrary to the natural coarseness trend described in FIG. 3.

The phase separated composite glass can have phase compositions approximately corresponding to tie-line endpoints of a pseudo-binary immiscibility dome defined by the natural phase separation of the same composition. For example, the phase separated composite glass can comprise a droplet phase and a matrix phase having compositions approximately corresponding to tie-line endpoints of a pseudo-binary immiscibility dome defining compositions of phases resulting from cooling a homogeneous melt of a composite glass having an equivalent bulk composition as the phase separated composite glass.

The phase separated composite glass can have an interfacial free-energy of mixing that is lower relative to the interfacial free-energy of mixing resulting from natural phase separation of the same material. The phase separated composite glass can be thermodynamically trapped, for example, at a free energy local minimum for which mixing results in a free-energy increase. The phase separated composite glass can be thermodynamically and kinetically stable, and energetically resistant to, or free, from spontaneous changes to microstructure, such as changes to phase composition, size, or morphology, at ordinary temperatures for use, storage, or processing. For example, the phase separated composite glass can be stable and free from spontaneous changes to microstructure, while having a meta-stable type microstructure, such as a droplet-in-matrix structure. The phase separated composite glass can be stable up to about 500° C., 600° C., 700° C., 800° C., 900° C., or 1000° C., or up to a temperature about 50%, 60%, 70%, 80%, or 90% of an isotherm tie-line between endpoints of an immiscibility dome defined by the first phase and second phase of the phase separated glass. In further aspects, the phase separated composite glass can be free of spontaneous changes to microstructure at a temperature equal to the isotherm tie-line between endpoints of an immiscibility dome defined by the first phase and second phase of the phase separated glass.

In aspects, an interphase can exist between the first phase and the second phase, where material from the first phase and second phase intermix. A thickness of this interphase can be about 100 nanometers (nm) or more to ensure good adhesion while being about 1% or less of the resulting average microstructure size (e.g., first cullet size) to prevent deviation from the predetermined microstructure size. For example, a thickness of this interphase can be from about 100 nm to about 1 μm, from about 200 nm to about 500 nm, or any range or subrange therebetween. Alternatively or additionally, a thickness of this interphase can be, as a percentage of an average microstructure size of the first phase, from about 0.001% to about 1%, from about 0.01% to about 0.5%, from about 0.02% to about 0.2%, from about 0.05% to about 0.1%, or any range or subrange therebetween.

The phase separated composite glass can have various bulk compositions. For example, the phase separated composite glass can have a bulk composition comprising SiO₂ as a primary component. The bulk composition can comprise SiO₂, B₂O₃, Al₂O₃, P₂O₅, one or more alkaline earth oxide, one or more alkali metal oxide, or any combination thereof. An exemplary glass composition can comprise from about 60 to about 80 mol % SiO₂, from about 5 to about 20 mol % B₂O₃, from about 0.5 to about 10 mol % Al₂O₃, from about 0.5 to about 5 mol % P₂O₅, from about 5 to about 20 mol % one or more alkaline earth oxide, and from about 0 to about 5 mol % one or more alkali metal oxide.

The phase separated composite glass can be stable such that it can be subsequently processed to provide further articles without loss of the predetermined microstructure. Such further processing can be performed at approximately the same temperature as the isotherm tie-line between endpoints of the previously determined binary, or pseudo-binary, immiscibility dome. Such further processing can be performed at a temperature at, below, or significantly below, the phase separation temperature, the melt temperature, or the glass transition temperature, such that it is processed at a low enough temperature such that the influence of temperature and kinetic effects are not sufficient to induce spontaneous or significant phase change. Examples of further processing can include, e.g., sintering, annealing, tempering, melting, shaping, rolling, stretching, extruding, coating, fabricating, cutting, and/or resilience testing.

The phase separated composite glass can also be further processed to generate or include additional microstructures, for example, by performing multiple heat treatments. For example, the various methods, or heating steps, described herein can be performed multiple times. In some aspects, multiple heat treatments can yield crystallized phases or complex microstructures having phases within a phase. Resilience of the microstructure to subsequent processing can represent an advantage that provides access to various glass articles.

The present disclosure further provides glass articles that include the phase separated composite glass described herein. Such glass articles can include, for example, mechanically-strengthened glass, chemically-resistant glass, functional glass, ceramics devices, glass filters, display glass, optical glass, optical devices, wave guides, lenses, communication fibers, and high refractive index contrast glass. For example, the phase separated composite glass can provide a coarse phase separated optical glass with high refractive index contrast for optical devices and wave guides.

The phase separated composite glass can be prepared from a first glass and a second glass having compositions corresponding to opposite ends of a tie-line of a chosen pseudo-binary immiscibility dome. The chosen pseudo-binary immiscibility dome can be derived from phase separation and miscibility curves of a reference phase separated glass having one or more predetermined characteristic (e.g., a precursor glass or template glass). The resulting phase separated composite glass can have the same bulk composition as the reference glass, or it can have a different bulk composition. It is not necessary that the first glass and second glass be combined at the same ratio corresponding to the mole ratio of phases in the reference glass. For example, the phase separated composite glass can also have phases with the same endpoint compositions, but differing bulk compositions, based on the immiscibility dome of the corresponding precursor glass or template glass.

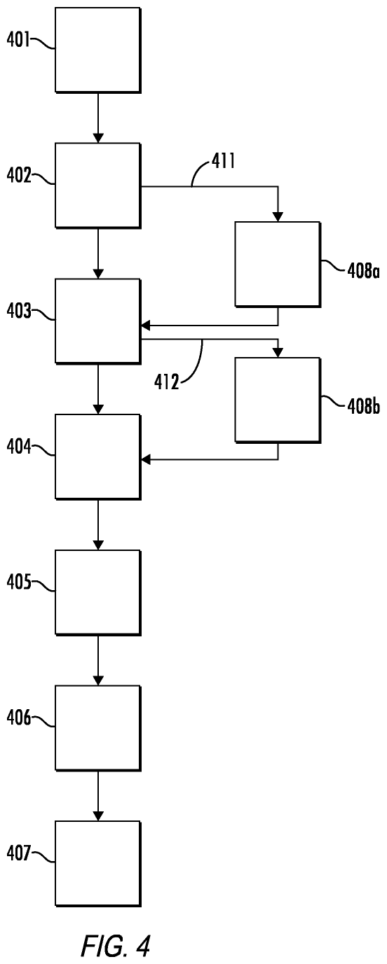

The disclosure further provides a method of preparing a phase separated composite glass from a precursor glass. FIG. 4 describes an example method of preparing a phase separated composite glass from a precursor glass. At block 401, a phase separated precursor glass having a first phase and a second phase is obtained. The precursor glass can be a glass having desirable characteristics, but for which differing morphology or larger microstructure size could be desirable. The precursor glass can be an immiscible liquid-liquid binary, or pseudo-binary, phase composition. The precursor glass can be a naturally phase separated and equilibrated glass, which can be prepared by cooling a homogeneous melt of the precursor glass and permitting it to phase separate and equilibrate prior to quenching. At block 402, each phase is analyzed to determine their approximate compositions. Determining the chemical compositions of each phase can be performed by, e.g., microprobe, TEM-EDS, computational image analysis, or a combination thereof. At block 403, the determined composition is used to individually obtain a first glass and a second glass approximately corresponding to the composition of the first phase and the second phase, respectively. At block 404, the first glass is milled to a first cullet size corresponding to a predetermined microstructure size of the target final product, and the second glass is milled to a second cullet size less than the first cullet size of the first glass. The first cullet size can be at least or about 10, 50, 100, 500, 1,000, 2,000, 3,000, 4,000, 5,000, 6,000, 7,000, 8,000, 9,000, or 10,000 times greater than the average, or largest, microstructure size in the precursor glass and/or greater than the natural coarsening limit of the precursor glass. For example, the first cullet size can be at least, about, or up to 100 μm, 0.5 mm, 1 mm, 5 mm, or 10 mm. At block 405, the milled first glass and the second milled second glass are combined to form a glass mixture. The milled first glass and the milled second glass can be combined in various ratios, and need not necessarily correspond to the ratio employed in the precursor glass, nor correspond to the same bulk composition of the precursor glass. The first and second glass can be combined at various temperatures, for example, at room temperature, or at a temperature below a glass transition temperature, a melting temperature, or phase separation temperature. At block 406, the combined glass mixture is heated and melted at a temperature from about 25° C. to 0° C., from about 20° C. to 0° C., from about 15° C. to 0° C., or from about 10° C. to 0° C. less than an isotherm tie-line between endpoints of a binary, or pseudo-binary, immiscibility dome defined by the first phase and second phase of the phase separated precursor glass. In aspects, the combined glass mixture can be heated at the temperature for about 20 minutes or less, for example, from about 1 minute to about 20 minutes, from about 5 minutes to about 15 minutes, or any range or subrange therebetween. Providing a temperature less than the isotherm tie-line and or limiting the time for block 406 (e.g., about 20 minutes or less), deformation of the milled first glass or other changes to the microstructure of the milled first glass can be minimized while still permitting localized interactions (e.g., diffusion bonding) at an interface between the first milled glass and the second milled glass, which can increase an adhesion (e.g., bonding). For example, an interphase can form around the first milled glass where material from the milled first glass and the milled second glass intermix, and a thickness of this interphase can be about 100 nanometers (nm) or more to ensure good adhesion while being about 1% or less of the resulting average microstructure size (e.g., first cullet size) to prevent deviation from the predetermined microstructure size. In aspects, the temperature that the combined glass mixture is heated at in block 406 can approximately correspond to the isotherm tie-line between endpoints of a binary, or pseudo-binary, immiscibility dome defined by the first phase and second phase of the phase separated precursor glass. The temperature can be determined based on a characteristic temperature of phase separation in the template glass, or precursor glass. This temperature can be estimated, as discussed herein, even without precise knowledge of what temperature settings were used to prepare the template glass or precursor glass. For example, the temperature can be within or about 10%, 9%, 8%, 7%, 6%, 5%, 4%, 3%, 2%, or 1% of the precursor-defined isotherm. In some aspects, the temperature can differ from said isotherm by 5% or more. In further aspects, the mixture is melted at a temperature at least, about, or up to 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., 1600° C., 1650° C., or 1700° C., or any combination thereof. In aspects, the mixture is melted at a temperature below the liquidus temperature. The heat treatment can result in a phase separated mixture, for example having an immiscible liquid-liquid binary, or pseudo-binary, mixture. The phase separated mixture can have a microstructure differing from the precursor glass, or in violation of the morphology constraints defined by a liquid-liquid immiscibility dome for the given bulk composition or for the precursor glass. At block 407, the heat treated mixture is quenched so as to kinetically trap the phase separated composite glass resulting from the heat treatment. In aspects, the phase separate composite glass can comprise an average microstructure size (e.g., effective diameter) that is within about 5%, within about 3%, within about 2%, or within about 1% of the first cullet size.

In aspects, as shown in FIG. 4, methods can comprise following arrow 411 from block 402 to block 408a. Block 408a comprises individually heating the first glass and/or the second glass to a temperature approximately corresponding to the isotherm tie-line corresponding to the compositions of the first phase and the second phase of the precursor glass. Alternatively, in aspects, as shown in FIG. 4, methods can comprise following arrow 412 from block 403 to block 408b. Block 408b comprises individually heating at least a portion of the milled first glass and/or the milled second glass to a temperature approximately corresponding to the isotherm tie-line corresponding to the compositions of the first phase and the second phase of the precursor glass. Without wishing to be bound by theory, block 408a or 408b can reduce phase separation or microstructure changes at block 406, for example, by allowing the microstructure and/or composition of the heated glass or heated milled glass to move closer to a free energy minimum at the temperature corresponding to the isothermal tie line. Also, block 408a or 408b can enable the temperature to be used in block 406 to be refined without forming and/or discarding a phase separated glass composite, for example, if significant changes in microstructure and/or composition are observed (e.g., phase separation occurs within the individually heated glass or heated milled glass), then the temperature can be adjusted and tested by reheating the glass or milled class to see if the corresponding composition approximately corresponds to an equilibrated composition obtained in block 408a or 408b. In aspects, block 408a can be used (e.g., instead of block 408b), for example, if (1) the first glass and/or the second glass is prone to volatilization, which can be reduced by using a the bulk that has a lower surface area than the milled glass with the same volume as the bulk, and/or if (2) a viscosity of first glass and/or the second glass at the temperature of the isothermal tie line is low enough that a milled glass would not be able to maintain its microstructure and/or shape at this temperature. On the other hand, block 408b can be used (e.g., instead of block 408a), for example, if the first glass and/or the second glass is prone to crystallization since a more uniform temperature can be achieved by heating the milled glass rather than the corresponding glass bulk. At the end of step 408a or 408b, the first glass, milled first glass, second glass, and/or second milled glass can be quenched to prevent the corresponding microstructure and/or composition from changing during cooling.

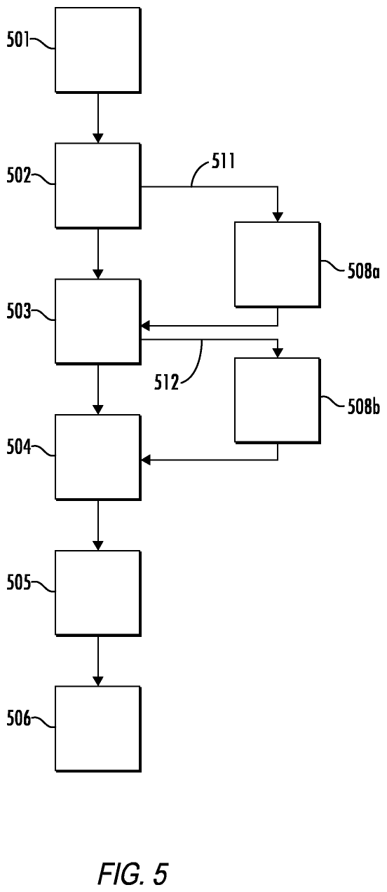

The disclosure further provides a method of preparing a phase separated composite glass from a template glass. FIG. 5 describes an example method of preparing a phase separated composite glass from a template glass. At block 501, a phase separated template glass is selected. The template glass can be a glass having desirable characteristics, but for which differing morphology or larger microstructure size could be desirable. The template glass can be an immiscible liquid-liquid binary, or pseudo-binary, phase composition. The template glass can be a naturally phase separated and equilibrated glass, prepared by cooling a homogeneous melt of the template glass and permitting it to phase separate and equilibrate prior to quenching. At block 502, a first glass and a second glass are obtained having compositions that correspond to each phase of the template glass. Determination of phase composition can be performed via microprobe, TEM-EDS, computational image analysis, or a combination thereof. At block 503, the first glass is milled to a first cullet size corresponding to a predetermined microstructure size of the target final product, and the second glass is milled to a second cullet size less than the first cullet size of the first glass. The first cullet size can be at least or about 10, 50, 100, 500, 1,000, 2,000, 3,000, 4,000, 5,000, 6,000, 7,000, 8,000, 9,000, or 10,000 times greater than the average, or largest, microstructure size in the template glass, or greater than the natural coarsening limit of the template glass. For example, the first cullet size can be at least, about, or up to 100 μm, 0.5 mm, 1 mm, 5 mm, or 10 mm. At block 504, the milled first glass and the milled second glass are combined to form a glass mixture. The milled first glass and the milled second glass can be combined in various ratios, and need not necessarily correspond to the ratio employed in the template glass, nor correspond to the same bulk composition of the template glass. At block 505, the combined glass mixture is heated and melted at a temperature from about 25° C. to 0° C., from about 20° C. to 0° C., from about 15° C. to 0° C., or from about 10° C. to 0° C. less than an isotherm tie-line between endpoints of a binary, or pseudo-binary, immiscibility dome defined by the first phase and second phase of the phase separated precursor glass. In aspects, the combined glass mixture can be heated at the temperature for about 20 minutes or less, for example, from about 1 minute to about 20 minutes, from about 5 minutes to about 15 minutes, or any range or subrange therebetween. Providing a temperature less than the isotherm tie-line and or limiting the time for block 505 (e.g., about 20 minutes or less), deformation of the milled first glass or other changes to the microstructure of the milled first glass can be minimized while still permitting localized interactions (e.g., diffusion bonding) at an interface between the first milled glass and the second milled glass, which can increase an adhesion (e.g., bonding). For example, an interphase can form around the first milled glass where material from the milled first glass and the milled second glass intermix, and a thickness of this interphase can be about 100 nanometers (nm) or more to ensure good adhesion while being about 1% or less of the resulting average microstructure size (e.g., first cullet size) to prevent deviation from the predetermined microstructure size. In aspects, the temperature that the combined glass mixture is heated at in block 505 can approximately correspond to the isotherm tie-line between endpoints of a binary, or pseudo-binary, immiscibility dome defined by the first phase and second phase of the phase separated precursor glass. The temperature can be determined based on a characteristic temperature of phase separation in the template glass, or precursor glass. This temperature can be estimated, as discussed herein, even without precise knowledge of what temperature settings were used to prepare the template glass or precursor glass. For example, the temperature can be within or about 10%, 9%, 8%, 7%, 6%, 5%, 4%, 3%, 2%, or 1% of the precursor-defined isotherm. In some aspects, the temperature can differ from said isotherm by 5% or more. In further aspects, the mixture is melted at a temperature at least, about, or up to 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., 1600° C., 1650° C., or 1700° C., or any combination thereof. In aspects, the mixture is melted at a temperature below the liquidus temperature. The heat treatment can result in a phase separated mixture, for example having an immiscible liquid-liquid binary, or pseudo-binary, mixture. The phase separated mixture can have a microstructure differing from the template glass, or in violation of the morphology constraints defined by a liquid-liquid immiscibility dome for the given bulk composition or for the template glass. At block 506, the heat treated mixture is quenched so as to kinetically trap the phase separated composite glass resulting from the heat treatment. In aspects, the phase separate composite glass can comprise an average microstructure size (e.g., effective diameter) that is within about 5%, within about 3%, within about 2%, or within about 1% of the first cullet size.

In aspects, as shown in FIG. 5, methods can comprise following arrow 511 from block 502 to block 508a. Block 508a comprises individually heating the first glass and/or the second glass to a temperature approximately corresponding to the isotherm tie-line corresponding to the compositions of the first phase and the second phase of the template glass. Alternatively, in aspects, as shown in FIG. 5, methods can comprise following arrow 512 from block 503 to block 508b. Block 509b comprises individually heating at least a portion of the milled first glass and/or the milled second glass to a temperature approximately corresponding to the isotherm tie-line corresponding to the compositions of the first phase and the second phase of the template glass. Without wishing to be bound by theory, block 508a or 508b can reduce phase separation or microstructure changes at block 506, for example, by allowing the microstructure and/or composition of the heated glass or heated milled glass to move closer to a free energy minimum at the temperature corresponding to the isothermal tie line. Also, block 508a or 508b can enable the temperature to be used in block 506 to be refined without forming and/or discarding a phase separated glass composite, for example, if significant changes in microstructure and/or composition are observed (e.g., phase separation occurs within the individually heated glass or heated milled glass), then the temperature can be adjusted and tested by reheating the glass or milled class to see if the corresponding composition approximately corresponds to an equilibrated composition obtained in block 508a or 508b. In aspects, block 508a can be used (e.g., instead of block 508b), for example, if (1) the first glass and/or the second glass is prone to volatilization, which can be reduced by using a the bulk that has a lower surface area than the milled glass with the same volume as the bulk, and/or if (2) a viscosity of first glass and/or the second glass at the temperature of the isothermal tie line is low enough that a milled glass would not be able to maintain its microstructure and/or shape at this temperature. On the other hand, block 508b can be used (e.g., instead of block 508a), for example, if the first glass and/or the second glass is prone to crystallization since a more uniform temperature can be achieved by heating the milled glass rather than the corresponding glass bulk. At the end of step 508a or 508b, the first glass, milled first glass, second glass, and/or second milled glass can be quenched to prevent the corresponding microstructure and/or composition from changing during cooling.

A further example method for preparing the phase separated composite glass can involve the following steps:
(1) melt a precursor glass, which phase separates into two phases;
(2) determine approximate compositions of the two phases;
(3) melt a first composition and a second composition corresponding to the two phases determined in step 2 individually;
(4) mill the droplet and matrix compositions to a specific particle size distributions to achieve a target microstructure size in the glass, once they are combined and remelted;
(5) combine the glasses defined in step 2, produced in step 3, and milled to target particle size distribution in step 4, at room temperature in any proportion;
(6) remelt the now mixed glasses from step 5 at the characteristic temperature that corresponds to the tie-line endpoint chemistries that were characterized in step 2; and
(7) obtain the resulting material, which can be a droplet-in-matrix-like composite, but with the predetermined microstructure size that is not constrained by the kinetic coarsening considerations of a traditionally formed phase-separated microstructure that would result from a homogeneous precursor glass.

A further example method for preparing the phase separated composite glass can involve the following steps:
(1) melt a precursor glass, which phase separates into two phases;
(2) determine approximate compositions of the two phases;
(3) melt a first composition and a second composition corresponding to the two phases determined in step 2 individually;
(4) heat the first phase and/or the second phase individually at a predetermined temperature estimated to correspond to the isothermal tie-line corresponding to the compositions of the first phase and the second phase of the precursor glass;
(5) mill the droplet and matrix compositions to a specific particle size distributions to achieve a target microstructure size in the glass, once they are combined and remelted;
(6) combine the glasses defined in step 2, produced in step 3, and milled to target particle size distribution in step 4, at room temperature in any proportion;
(7) remelt the now mixed glasses from step 5 at a temperature from about 25° C. to 0° C. less than the characteristic temperature that corresponds to the tie-line endpoint chemistries that were characterized in step 2, where the melting occurs for from 1 minute to 20 minutes; and
(8) obtain the resulting material, which can be a droplet-in-matrix-like composite, but with the predetermined microstructure size that is not constrained by the kinetic coarsening considerations of a traditionally formed phase-separated microstructure that would result from a homogeneous precursor glass.

A further example method for preparing the phase separated composite glass can involve the following steps:
(1) melt a precursor glass, which phase separates into two phases;
(2) determine approximate compositions of the two phases;
(3) melt a first composition and a second composition corresponding to the two phases determined in step 2 individually;
(4) mill the droplet and matrix compositions to a specific particle size distributions to achieve a target microstructure size in the glass, once they are combined and remelted;
(5) heat at least a portion of the milled first phase and/or at least a portion of the milled second phase individually at a predetermined temperature estimated to correspond to the isothermal tie-line corresponding to the compositions of the first phase and the second phase of the precursor glass;
(6) combine the glasses defined in step 2, produced in step 3, and milled to target particle size distribution in step 4, at room temperature in any proportion;
(7) remelt the now mixed glasses from step 5 at a temperature from about 25° C. to 0° C. less than the characteristic temperature that corresponds to the tie-line endpoint chemistries that were characterized in step 2, where the melting occurs for from 1 minute to 20 minutes; and
(8) obtain the resulting material, which can be a droplet-in-matrix-like composite, but with the predetermined microstructure size that is not constrained by the kinetic coarsening considerations of a traditionally formed phase-separated microstructure that would result from a homogeneous precursor glass.

Various methods described herein can represent an approach to producing phase separated glass that opens up a new parameter space for creating phase separated materials and, further, can provide a degree of control toward rationally-guided design of phase separated composite glasses.

Without intending to limit to any particular theory of operation, it is thought that use of the selected first and second glass compositions and temperature can result in phase separated state in a free energy local minimum, which minimizes the thermal driving force for mixing. It is thought that the presence of this local minimum can be temperature dependent; for example, for a typical dome-shaped immiscibility curve there exists a corresponding free energy curve. Depending on temperature and composition, the free energy curve can have a U-shape (e.g., higher temperatures), which can transition toward an M-shape, toward an upside down U-shape (e.g., at lower temperatures). Thus, for a given immiscibility dome, the upper dome corresponds to low AG of mixing, faster kinetics of mixing/demixing, coarse structures, and low refractive index contrast; the lower dome corresponds to high AG of mixing, slower kinetics of mixing/demixing, fine structures, and high refractive index of contrast. In aspects, the present disclosure provides phase separated composite glass having a reduced AG of mixing, slower kinetics of mixing, coarse structures, and high refractive index contrast. The resulting phase separated glass can have microstructure size and morphology that overcomes natural kinetic limitations imposed on microstructure formation relative to natural phase separation. The interfacial free energy at the surface contact of melted first and second glass compositions can be lower than would be achieved in a natural phase separation process, which can further reduce the driving force for change within the resulting phase separated system. This minimizing of thermodynamic forces on the local level so as to prevent mixing may also explain the ability of the phase separated glass compositions to deviate from the naturally limited phase proportions defined by the immiscibility dome and tie-line endpoints for the given bulk composition.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The terms “about” and “approximately” as used herein can each allow, individually, for a degree of variability in a value, range, or specified amount, for example, within 10%, within 5%, or within 1% of a stated value or amount, or of a stated limit of a range. The phrase “approximately corresponding to” as used herein also allows for a degree of variability in a value, range, or specified amount, for example, within 10%, within 5%, or within 1% of a stated value or amount, or of a stated limit of a range. In some uses, as may be provided by context, the phrase “approximately corresponding to” allows for a degree of variability when referring to a characteristic, e.g., a chemical characteristic, that is “approximately” the same as or “approximately” equal to the referenced characteristic. As used herein, a composition that is “approximately corresponding to” a reference composition refers to a composition that is the same, or similar, e.g., within 10%, within 5%, or within 1% of the reference value, based on the referenced units. Unless otherwise specified, approximate comparisons of chemical compositions made herein understood in terms of comparing the mole fraction of the individual components, e.g., AₓB_{y}C_{z}, for which each of x, y, and z are individually allowed a degree of variability in value, e.g., within 10%, within 5%, or within 1%.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

### EXAMPLES

It is understood that the examples and embodiments described herein are for illustrative purposes only and that various modifications or changes in light thereof will be suggested to one skilled in the art without departing from the scope of the present disclosure.

### Example 1: Preparation of a Large Droplet Phase Separated Composite Glass

A phase separated precursor glass having a droplet phase and a matrix phase was selected based on having desirable characteristics, but for which a differing morphology, or larger droplet size, of the phases was to be achieved.

The precursor glass was melted, and the bulk and phase compositions of the precursor glass was determined. The precursor glass used in this example had a composition as set forth in Table 1. The overall (bulk) glass composition was determined by ICP-MS and OED analysis, and the phase (matrix and droplet) compositions were calculated by computational analysis of microscopy images. The precursor glass exhibited a natural coarsening limit of around 500 nm, which corresponded to the maximum observed droplet size. A TEM image of the precursor material is provided in FIG. 1. Droplet size was determined by selecting a representative area, e.g., about 5×5 μm, from the TEM image and measuring droplet sizes to determine a maximum droplet size.

TABLE 1
Precursor Glass Composition

| | Matrix (mol %) | Bulk Glass (mol %) | Droplet (mol %) |
|---|---|---|---|
| SiO₂ | 81.80 | 70.72 | 38.54 |
| Al₂O₃ | 10.53 | 13.04 | 20.33 |
| Al₂O₃ | 1.37 | 1.50 | 1.91 |
| P₂O₅ | 0.36 | 0.81 | 2.11 |
| BaO | 1.98 | 6.02 | 17.74 |
| CaO | 1.77 | 4.91 | 14.03 |
| Na₂O | 2.19 | 3.00 | 5.34 |

Based on analysis of the precursor glass, an estimated characteristic temperature was selected based on estimating a tie-line isotherm which has endpoints corresponding to the previously calculated phase compositions. Here, a temperature of ˜1000° C. was selected, which was estimated to account for some cooling prior to quenching.

Two glasses, corresponding to the matrix and droplet compositions shown in Table 1, were individually melted.

The droplet and matrix glasses were each individually milled. The droplet glass was milled to a course cullet (>5 mm), and the matrix glass was milled to a fine cullet (<1 mm).

The two cullets were combined into a 1″×1″ Pt boat, which was placed in a furnace. The glass mixture was heated at the estimated characteristic temperature of 1000° C. for 1 hour, quenched, then annealed at 600° C. for 1 hour.

The resulting composite material exhibited a droplet size similar to the droplet glass cullet size, approximately 5 mm, which is 10,000 times larger than the natural droplet size resulting from naturally phase separated precursor glass.

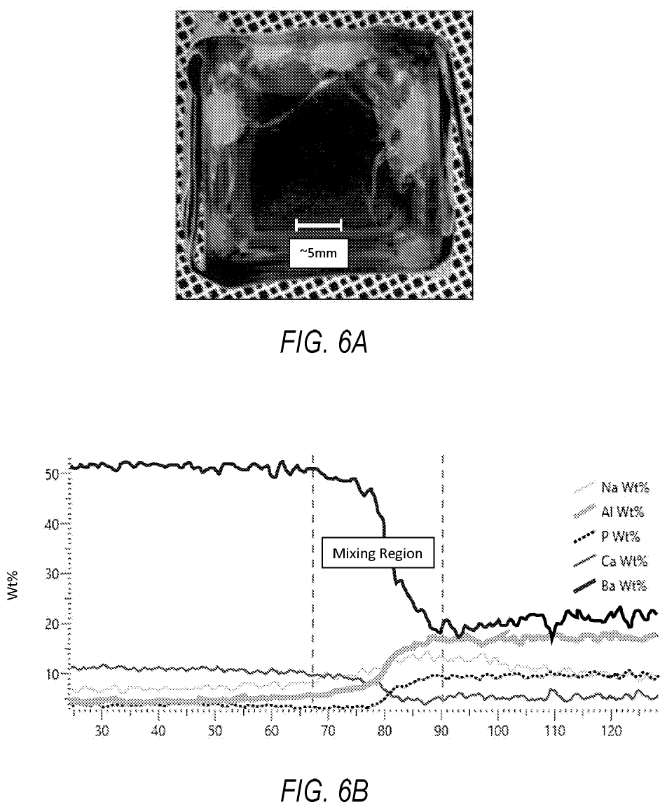

FIG. 6A provides a photograph of the resulting glass in a 2.54 cm (1 inch)×2.54 cm (1 inch) Pt boat, showing macroscopically visible droplets having a size of approximately 5 mm.

This result demonstrates that it is possible to achieve a phase separated glass having microstructure sizes greater than the normal coarsening limit of the phase separated glass. This type of approach to producing phase separated glass thus opens a new area of possible design space by accessing microstructure size and morphological constraints that are outside the limit of those available by natural phase separation as illustrated in FIG. 3.

This result also shows that use of an estimated, or approximate, characteristic temperature is sufficient to achieve a resulting microstructure that is stable and resilient against thermodynamically driven mixing. Indeed, even after heating for 1 hour at the characteristic temperature, and after an additional 1 hour of annealing, the microstructure remained intact.

This result shows that precise knowledge of the cooling conditions utilized during initial phase separation of the precursor material glass is not critical. A possible explanation of this is that the resulting microstructure occupies a local free energy minimum, which together with interfacial surfaces defined by milling, results in a reduced free-energy driving force for mixing. This result demonstrates that if a working temperature is selected that is close to the actual characteristic temperature for the tie-line endpoint glasses, even if not at the exact value, the associated free-energy driving force for mixing can be lower than would be seen in the homogeneous bulk glass precursor, which will reduce the extent of mixing observed at the working temperature.

The resulting glass was also analyzed via electron microscopy with EDS to determine phase chemical compositions of the resulting phases, and to examine phase transitions and morphology. The SEM and EDS results for individual atomic species in the final material show that the matrix phase is silica-rich, while the droplet glass is rich in modifiers, Ba, Ca, Na and P.

FIG. 6B provides an energy dispersive spectroscopy (EDS) line chart illustrating the difference in surface composition along a transition region from a droplet region (high-index, modifier rich) to a matrix region (low-index, silica-rich). The measured modifier diffusion from the high-index (modifier-rich) phase to the low-index (silica-rich) phase shows the thickness of the boundary to be a little over 10 μm.

This interdiffusion and transition region can be explained based on deviation from the characteristic temperature and duration of heating at the characteristic temperature. The 1 hour of heating at 1000° C. represents a significant longer period than the cooling time utilized to prepare the original precursor glass. Thus, while it is not necessary to precisely achieve the characteristic temperature, a more accurate recreation of the original phase separation conditions (temperature and time) would likely minimize interdiffusion.

1. A glass article comprising a phase separated composite glass having a first phase and a second phase, wherein the first phase has an average microstructure size greater than a natural coarsening limit of the phase separated composite glass.

2. The glass article of claim 1, wherein the first phase is a droplet phase, the second phase is a matrix phase, the average microstructure size is an average droplet size, and the average droplet size of the droplet phase is greater than the natural coarsening limit of the phase separated composite glass.

3. (canceled)

4. The glass article of claim 1, wherein an alternative phase separated composite glass obtained from cooling another homogeneous melt of a composite glass having an equivalent bulk composition to the phase separated composite glass to obtain a thermodynamically phase separated composite glass results in a spinodal decomposition morphology.

5. The glass article of claim 1, wherein the phase separated composite glass has an interfacial free-energy of mixing that is lower relative to an alternate interfacial free-energy of mixing resulting from cooling another homogeneous melt of a composite glass having an equivalent bulk composition to the phase separated composite glass.

6. The glass article of claim 1, wherein the first phase and the second phase have compositions approximately corresponding to tie-line endpoints of a pseudo-binary immiscibility dome defining compositions of phases resulting from cooling another homogeneous melt of a composite glass having an equivalent bulk composition of the phase separated composite glass.

7. The glass article of claim 1, wherein the average microstructure size of the first phase is at least 10 times greater than the natural coarsening limit of the phase separated composite glass.

8.-9. (canceled)

10. The glass article of claim 2, wherein the phase separated composite glass has a bulk composition comprising:
from about 60 to about 80 mol % SiO₂:
from about 5 to about 20 mol % B₂O₃:
from about 0.5 to about 10 mol % Al₂O₃;
from about 0.5 to about 5 mol % P₂O₅:
from about 5 to about 20 mol % one or more alkaline earth oxide; and from about 0 to about 5 mol % one or more alkali metal oxide,
wherein the average droplet size of the first phase is from about 0.01 millimeters to about 10 millimeters.

11. The glass article of claim 1, wherein an interphase between the first phase and the second phase is from about 100 nanometers to about 1% of the average microstructure size.

12. A method of preparing a phase separated composite glass, comprising:
obtaining a phase separated precursor glass having a first phase and a second phase:
determining a composition of the first phase and the second phase:
individually obtaining a first glass and a second glass approximately corresponding to the composition of the first phase and the second phase, respectively:
milling the first glass to a first cullet size corresponding to a predetermined microstructure size:
milling the second glass to a second cullet size less than the first cullet size of the first glass:
combining the milled first glass and the milled second glass to form a glass mixture:
melting the glass mixture at a temperature from about 25° C. to 0° C. less than an isotherm tie-line between endpoints of a pseudo-binary immiscibility dome defined by the first phase and the second phase of the phase separated precursor glass; and then
quenching, so as to provide the phase separated composite glass.

13. The method of claim 12, wherein the phase separated composite glass has a microstructure with a microstructure morphology, a microstructure size, or both that is in violation of natural phase separation constraints as defined by the pseudo-binary immiscibility dome based on phase separation from cooling a homogeneous melt of the phase separated precursor glass.

14. The method of claim 13, wherein the microstructure size is greater than an upper bound of corresponding microstructure size in the phase separated precursor glass.

15. The method of claim 13, wherein the phase separated composite glass has a droplet phase and a matrix phase, and the microstructure is droplets.

16. The method of claim 12, wherein the milled first glass and the milled second glass are combined at different relative proportion compared to the first phase and the second phase in the phase separated precursor glass.

17. (canceled)

18. The method of claim 12, wherein the phase separated composite glass has phases having compositions approximately corresponding to that of tie-line endpoints of the pseudo-binary immiscibility dome defined by the first phase and the second phase of the phase separated precursor glass.

19. The method of claim 12, wherein the phase separated composite glass has an average microstructure size greater than a natural coarsening limit of the phase separated precursor glass.

20. The method of claim 12, further comprising, after individually obtaining the first glass and the second glass but before combining the milled first glass and the milled second glass:
heating the first glass or the milled first glass at a temperature at a temperature approximately corresponding to the isotherm tie-line; and
heating the second glass or the milled second glass at a temperature at a temperature approximately corresponding to the isotherm tie-line.

21. The method of claim 12, wherein an average microstructure size of the first phase in the phase separated composite glass is within about 5% of the first cullet size.

22. A method of preparing a phase separated composite glass, comprising:
selecting a thermodynamically phase separated template glass prepared by cooling a homogeneous melt of a template glass to obtain a first phase and a second phase:
obtaining a first glass approximately corresponding to a composition of the first phase and milling it to a first cullet size corresponding to a predetermined microstructure size greater than an upper bound of corresponding microstructure size in the thermodynamically phase separated template glass:
obtaining a second glass approximately corresponding to a composition of the second phase and milling it to a second cullet size less than the first cullet size of the first glass;
combining the milled first glass and the milled second glass to form a glass mixture:
melting the glass mixture at a temperature from about 25° C. to 0° C. less than an isotherm tie-line between endpoints of a pseudo-binary immiscibility dome defined by the first phase and the second phase of the thermodynamically phase separated template glass: and
quenching, so as to provide the phase separated composite glass.

23. The method of claim 22, further comprising, after individually obtaining the first glass and the second glass but before combining the milled first glass and the milled second glass:
heating the first glass or the milled first glass at a temperature at a temperature approximately corresponding to the isotherm tie-line; and
heating the second glass or the milled second glass at a temperature at a temperature approximately corresponding to the isotherm tie-line.

24. (canceled)

25. The method of claim 12, wherein the glass mixture is held at the temperature from about 25° C. to 0° C. less than the isotherm tie-line for a period of time from about 1 minute to about 20 minutes.
